(19) United States
(12) Patent Application Publication
(10) Pub. No.: US 2023/0068735 A1
(43) Pub. Date: Mar. 2, 2023

(54) INDIVIDUAL AIR CONDITIONING CONTROL SYSTEM FOR ELECTRIC AUTOMOBILE

(71) Applicants: Hyundai Motor Company, Seoul (KR); Kia Corporation, Seoul (KR); Doowon Climate Control Co., Ltd., Asan-si (KR)

(72) Inventors: Seok-Jun OH, Whasung-Si (KR); Jeong-Woong Son, Whasung-Si (KR); Dong-Won Yeon, Whasung-Si (KR); Jun-Hong Choi, Whasung-Si (KR); Byeong-Guk An, Whasung-Si (KR)

(21) Appl. No.: 17/884,035

(22) Filed: Aug. 9, 2022

(30) Foreign Application Priority Data
Aug. 31, 2021 (KR) 10-2021-0115767

(51) Int. Cl. B60H 1/00

(52) U.S. Cl. CPC B60H 1/00821; B60H 1/00392

(57) ABSTRACT

An individual air conditioning control system for an electric vehicle, includes a heating, ventilation, and air conditioning (HVAC) body, an evaporator provided in the HVAC body, a PTC heater, an input unit for receiving set temperature of each of a driver's seat and a passenger's seat, left and right temperature sensing units of sensing an air temperature passing through a left side and a right side of the PTC heater, a control unit of outputting a control signal for controlling the PTC heater based on the set temperature input from the input unit and a measurement temperature measured from each of the left and right temperature sensing units, and a power supply unit of adjusting power supplied to the PTC heater according to the output PWM control signal of the control unit.

### CROSS-REFERENCE TO RELATED APPLICATIONS

The present application claims priority to Korean Patent Application No. 10-2021-0115767, filed on Aug. 31, 2021, the entire contents of which is incorporated herein for all purposes by this reference.

### BACKGROUND OF THE PRESENT DISCLOSURE

### Field of the Present Disclosure

The present disclosure relates to an individual air conditioning control system for an electric automobile. More particularly, the present disclosure relates to an individual air conditioning control system for an electric automobile, which has a heating, ventilation, & air conditioning (HVAC, PE room position) and an indoor distributor separated from each other, and is capable of performing a 4-zone (front left and right seats and rear left and right seats) control by use of one blower.

### Description of Related Art

Recently, it is an electric automobile which is emerging as a social issue, such as implementation of environmentally friendly technology and environmental depletion. The electric automobile is operated using a motor receiving electricity from a battery and outputting power. Therefore, there is no discharge of carbon dioxide, noise is very small, and the energy efficiency of the motor is higher than the energy efficiency of the engine, and the electric automobile is attracted as an eco-friendly car.

In implementing the electric automobile, a core technology is a technology related to a battery module, and in recent years, a research into lightweight, miniaturization, a short charge time, etc., of the battery, has been actively made. Only when the battery module is used in an optimal temperature environment, optimal performance and a long life-span can be maintained. However, it is difficult to use the battery module in the optimal temperature environment by heat generated while driving and an external temperature change.

In the electric automobile, because there is no waste heat source generated from a separate engine during combustion like an internal combustion engine, vehicle indoor heating is performed in the winter by use of an electric heating device, and warm-up is required to enhance battery charge and discharge performance in a cold weather condition, and as a result, a separate cooling water heating electric heater is configured and used. That is, a technology is adopted, which operates a cooling/heating system for adjusting a temperature of the battery module apart from a cooling/heating system for vehicle indoor air conditioning to maintain the optimal temperature environment of the battery module.

In other words, two independent cooling/heating systems are constructed, and one is used for indoor cooling/heating and the other one is used for adjusting the temperature of the battery module.

However, when the cooling/heating system is operated by such a method, energy cannot be efficiently managed, and as a result, a cruising distance is short and long-range driving is thus impossible, and a driving distance is reduced by 30% or more during cooling in the summer and 40% or more during heating in the winter, and a heating problem in the winter, which is not issued in the internal combustion engine becomes more serious. A battery cooling/warm-up system of the electric automobile in the related art performs cooling upon operating an air conditioner and warm-up upon operating heating by use of indoor air, but consumed power increases during cooling/warm-up and a battery cell space needs to be expanded compared with using a liquid fluid (cooling water) upon cooling/warming up the battery with air, and there is a limit in expansion of the number of cells due to package space expansion and additional weight expansion, and an air temperature gradually rises when passing through the battery cell, and a temperature deviation between an inlet cell and an outlet cell is severe, and as a result, it is difficult to operate the battery with maximum efficiency.

Therefore, when the temperature of the battery is raised, a cooling water temperature is raised by a separate electric device and the battery is warmed up through the raised cooling water temperature, and the temperature of the battery is maintained at 38 to 42° C. to be operated with optimal efficiency, but each of an indoor heating electric heater and an electric heater for raising the temperature of the battery is separately applied, and a lot of energy waste elements are generated in a cost rise factor and a heater operation.

A configuration therefor will be described in brief as follows with reference to FIG. 1.

The heating device for the vehicle is constituted by an evaporator 20 embedded in a body 10, a PTC heater 30, an input unit 40 receiving predetermined temperature of each of a driver's seat and a passenger's seat, left and right temperature sensing units 50 and 60 sensing an air temperature passing through a left side and a right side of the PTC heater 30, a control unit 70 outputting a PWM control signal for controlling the PTC heater 30 based on the set temperature input from the input unit 40 and a measurement temperature measured from each of the left and right temperature sensing units 50 and 60, and a power supply unit 80 adjusting power supplied to the PTC heater 30 according to the output PWM control signal of the control unit 70.

In the HVAC body 10, a ventilation discharge path 11 for cooling/heating interior of the vehicle is formed on one upper side, a defrost discharge path 12 for removing an ice generated on a window is formed on the other upper side, a foot discharge path 13 for discharging air toward a foot is formed in the rear, and an air inflow hole 14 through which external air is introduced is formed in the front.

The heating device for the vehicle using the PTC heater configured as above is a technology that utilizes a positive temperature coefficient (PTC) heater and individually outputs left and right heater source portions, and differently applies left and right temperatures of the PTC heater to adjust the air temperature discharged to the driver's seat and the passenger's seat, and as a result, a size of a heater unit is decreased and the number of components is reduced, reducing easiness of manufacturing and a weight.

The heating device for the vehicle using the PTC heater improves a control method of the PTC heater 30 without a mix door to individually adjust the temperatures of the driver's seat and the passenger's seat.

Accordingly, in the case of a problem of the technology, a problem in that only individual temperature control for a front seat is possible and individual temperature control for a rear seat is impossible occurs.

Because there is no bypass door controlling a cold wind immediately passing through the evaporator 20, there is a problem in that indoor freshness (keeping head cool and feet warm) deteriorates upon adjusting the temperature.

Furthermore, because only the PTC heater is used, an electric mileage is inferior under a mild condition.

As illustrated in FIG. 2, the present disclosure is constituted by a body 10 having the air inflow hole 15 formed at one side and a plurality of air discharge holes 16 formed at the other side, a heat exchanger installed on an air passage in the HVAC body 10, i.e., a heater 30 installed upstream side of an air flow direction in the HVAC body 10, and an evaporator 20 installed a downstream side and having inlet and outlet pipes to introduce and discharge refrigerant, and air changed to a warm wind while passing through the heater 30 passes through the evaporator 20, and then is immediately discharged to the air discharge hole 16 opened according to an air conditioning mode (a vent mode, a bi-level mode, a floor mode, a mix mode, and defrost mode) and supplied to each part of a vehicle interior to perform heating of the vehicle interior.

A modern door 17 for opening/closing the discharge hole is provided in the discharge hole 16, and the modern door 17 is constituted by a sliding door portion 17a and a gear shaft 17b which is gear-coupled.

Even in the air conditioner configured as above, there is a problem that only individual temperature control for a front seat which is a basic problem is possible and individual temperature control for a rear seat is impossible occurs.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an air conditioning system adopting a 4-zone HV PTC heater for a temperature control of each of front left and right seats/rear left and right seats (for convenience, hereinafter, referred to as ‘4ZONE’) and adopting a bypass door for enhancement of indoor freshness and an internal condenser for enhancement of an electric mileage under a mild condition.

The present disclosure includes: a heating, ventilation, and air conditioning (HVAC) body; an evaporator provided in the HVAC body, a PTC heater, an input unit for receiving set temperature of each of a driver's seat and a passenger's seat, left and right temperature sensing units of sensing an air temperature passing through a left side and a right side of the PTC heater, a control unit of outputting a control signal for controlling the PTC heater based on the set temperature input from the input unit and a measurement temperature measured from each of the left and right temperature sensing units; and a power supply unit of adjusting power supplied to the PTC heater according to the output control signal of the control unit, a warm wind or a cold wind is discharged to the driver's seat and the passenger's seat according to the control signal of the control unit, the HVAC air conditioning control system is separated by a partition and an indoor distributor provided in the HVAC body to enable 4-zone (front left and right seats and rear left and right seats) control by use of one blower, the partition is provided to be horizontally airtight at an intermediate position of the evaporator and the heater 30 provided in the HVAC body, and the indoor distributor includes a front seat valve provided in a front seat discharge hole, and a rear seat valve provided in a rear seat discharge hole to distribute a wind output from the HVAC body to each discharge hole.

According to an exemplary embodiment of the present disclosure having such a configuration, the following effect can be obtained upon cooling and heating.

First, under a maximum (MAX) cooling condition, a cold wind passing through the evaporator prevents hot refrigerant from flowing to an internal condenser by use of a three-way valve and a 4-zone HV PTC heater is turned off to secure cooling performance and a bypass door is opened to minimize air ventilation resistance which moves to an air vent and a front seat air volume door and a rear seat air volume door are fully opened to secure an air volume to the maximum.

Second, under a general cooling condition, an overall window temperature is raised and when a temperature is different for each zone, a target final temperature for each zone is made by use of the 4-zone HV PTC heater, and resistance of the wind is made by changing an angle of at least one of a front seat air volume control door and a rear seat air volume control door to control the air volume for each zone to control the air volume.

Third, under a maximum (MAX) heating condition, a temperature of a wind generated while a cold wind passing through the evaporator passes through the internal condenser and the 4-zone HV PTC heater is raised to discharge the wind at a maximum heating temperature.

Fourth, under a general heating condition, the temperature in the internal condenser is raised by changing an opening level of the three-way valve, the cold wind passing through the evaporator raises an overall wind temperature while passing through a front seat air volume control door, and when the temperature is different for each zone, the target final temperature is discharged for each zone by use of the 4-zone HV PTC heater.

To control the air volume for each zone, resistance of the wind is made by changing angles of the front seat air volume control door and a rear-seat air volume control door to control the air volume.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram schematically illustrating a configuration of a heating device for a vehicle using a PTC heater in related art.

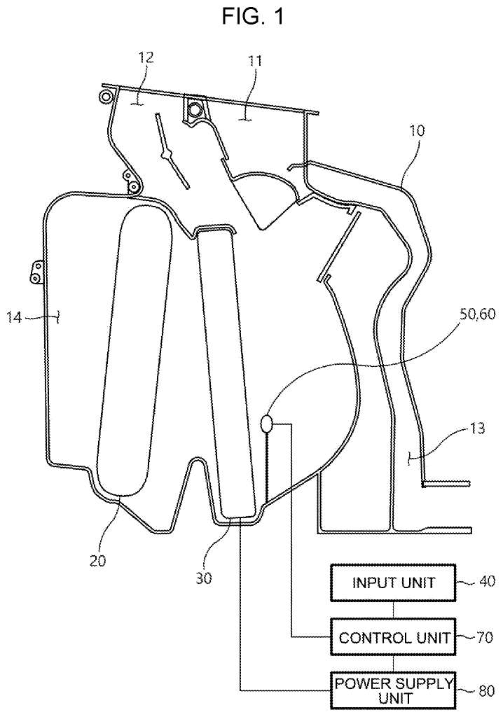

FIG. 2 is a diagram schematically illustrating another air conditioning device for a vehicle in the related art.

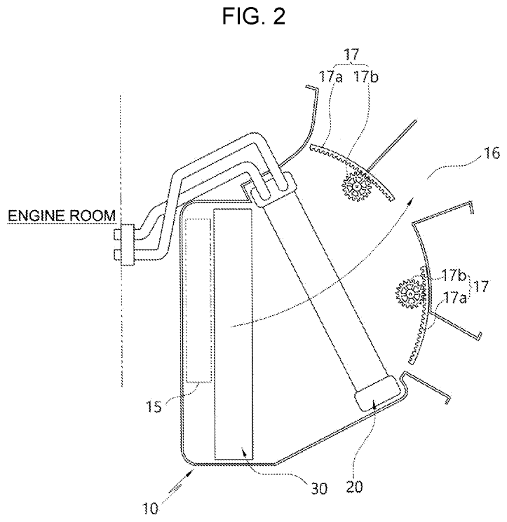

FIG. 3 is a diagram schematically illustrating an individual air conditioning control system for an electric vehicle according to an exemplary embodiment of the present disclosure to describe the individual air conditioning control system for an electric vehicle.

FIG. 4 is a diagram illustrating a movement path of an air volume under a MAX cooling condition of the individual air conditioning control system for an electric vehicle according to an exemplary embodiment of the present disclosure.

FIG. 5 is a diagram illustrating the movement path of the air volume under a general cooling condition of the individual air conditioning control system for an electric vehicle according to an exemplary embodiment of the present disclosure.

FIG. 6 is a diagram illustrating the movement path of the air volume under a MAX heating condition of the individual air conditioning control system for an electric vehicle according to an exemplary embodiment of the present disclosure.

FIG. 7 is a diagram illustrating the movement path of the air volume under a general heating condition of the individual air conditioning control system for an electric vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described more fully hereinafter with reference to the accompanying drawings to be easily implemented by those skilled in the art. However, the present disclosure can be realized in various different forms, and is not limited to the exemplary embodiments described herein.

A portion irrelevant to the description will be omitted to clearly describe the present disclosure, and the same elements will be designated by the same reference numerals throughout the specification.

Terms or words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his or her own invention in the best manner.

Hereinafter, a preferable embodiment of the present disclosure will be described in detail with reference to the accompanying drawings.

Various embodiments of the present disclosure relates to an individual air conditioning control system for an electric vehicle, and the individual air conditioning control system for an electric vehicle basically includes a heating, ventilation, and air conditioning (HVAC) body 10; and an evaporator 20 embedded in the HVAC body, a PTC heater 30, an input unit 40 receiving set temperature of each of a driver's seat and a passenger's seat, left and right temperature sensing units 50 and 60 sensing an air temperature passing through a left side and a right side of the PTC heater 30, a control unit 70 outputting a PWM control signal for controlling the PTC heater 30 based on the set temperature input from the input unit and a measurement temperature measured from each of the left and right temperature sensing units 50 and 60, and a power supply unit 80 adjusting power supplied to the PTC heater 30 according to the output PWM control signal of the control unit 70, and a configuration of a heating, ventilation, and air conditioning (HVAC) air conditioning control system which discharges a warm wind or a cold wind to a driver's seat and a passenger's seat according to the control signal of the control unit 70 is the same as that of the existing air conditioning system.

However, the present disclosure is characterized in that the present disclosure is separated by a partition 100 and an indoor distributor 200 in a heating, ventilation, and air conditioning (HVAC) body 10 and it is possible to control front left and right seats and rear left and right seats (hereinafter, referred to as ‘4 zones’) by use of one blower.

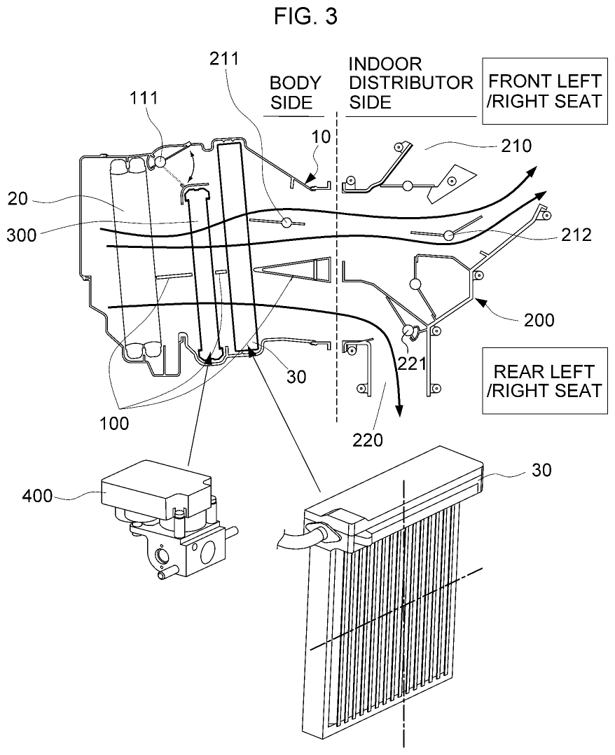

As illustrated in FIG. 3, the partition 100 is provided to be horizontally airtight at an intermediate position of the evaporator 20 and the heater 30 provided in the HVAC body 10, and in the indoor distributor 200, a mode door 212 is provided in a front seat discharge hole 210 to distribute a wind output from the HVAC body to each discharge hole.

For example, the partition 100 as a partition for partitioning an upper portion and a lower portion is a partition wall which allows a wind passing through a heating, ventilation, and air conditioning (HVAC) blower motor to be smoothly sent to each zone by passing through the evaporator 20 or the heater 30.

The temperature of a wind separated by the partition 100 is adjusted through the evaporator 20 and the heater 30 and resistance of the wind is given through angle adjustment of a front seat air volume control door 211 and a rear-seat air volume control door 221 to control the individual air volume control for each zone.

The indoor distributor 200 includes the front seat air volume control door 211, the mode door 212 provided at the front seat discharge hole 210, and the rear seat air volume control door 221 provided at the rear seat discharge hole 220 to send the wind output from the HVAC body 10 to each discharge hole, i.e., the front seat discharge hole 210.

The front seat air volume control door 211 is provided on the top portion of the partition at the heater 30 side, which enables the individual air volume control of the front seat discharge hole 210 by generating resistance to the flow of the window in the HVAC body 10 by adjusting the angle of the door and the rear seat air volume control door 221 is provided in the indoor distributor 200 on the bottom portion of the partition at the heater 30 side, which enables the individual air volume control of the rear seat discharge hole 220 by generating the resistance to the flow of the wind in the indoor distributor by adjusting the angle of the door.

Meanwhile, the internal condenser 300 for heating up the wind passing through a heat pump system in the evaporator 20 is provided between the evaporator 20 and the heater 30.

Furthermore, the bypass door 1111 is provided at an upper portion of the internal condenser 300 so that the cold wind immediately passes during maximum cooling.

The front seat air volume control door 212 is provided on the top portion of the partition at the heater 30 side, which enables the individual air volume control of the front seat discharge hole 210 by generating the resistance to the flow of the wind in the HVAC body 10 by adjusting the angle of the door.

The rear seat air volume control door 221 is provided in the indoor distributor 200 on the bottom portion of the partition at the heater 30 side, which enables the individual air volume control of the rear seat discharge hole 220 by generating the resistance to the flow of the wind in the indoor distributor by adjusting the angle of the door.

The three-way valve 400 is provided between the evaporator 20 and the heater 30 to block hot refrigerant which flows to the internal condenser 300 during cooling.

Meanwhile, the heater 30 adopts a 4-zone HV PTC heater which is vertically separated around the partition 100, but enables adjustment of a heating step for each of upper left and right zones and lower left and right zones.

An operation of the HVAC air conditioning control system configured as above will be referred to as below with reference to drawings.

Under the maximum (MAX) cooling condition,

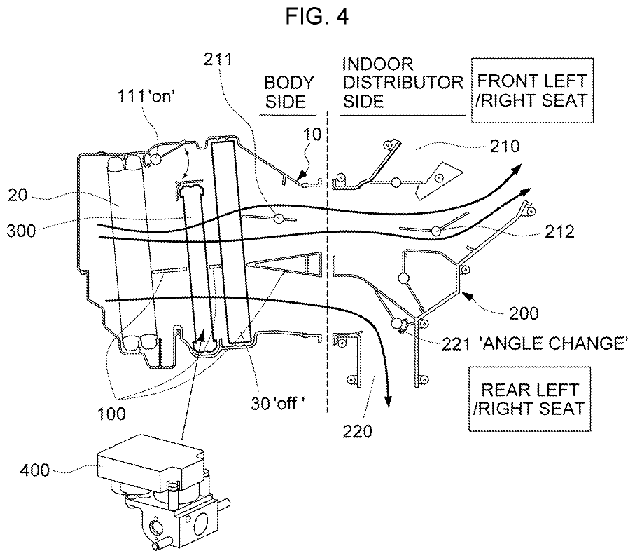

As illustrated in FIG. 4, the cold wind passing through the evaporator 20 prevents the hot refrigerant from flowing to the internal condenser 300 by the three-way valve 400, the 4-zone HV PTC heater 30 is turned off to secure cooling performance, and the bypass door 111 is ‘opened’ to minimize ventilation resistance which moves to the air vent (discharge hole) and the front/rear seat air volume door 211/221 is fully opened to secure the air volume to the maximum.

In the instant case, the mode door 212 is also in a fully opened state.

Under the general cooling condition (when the temperature and the air volume are different for each of 4 zones),

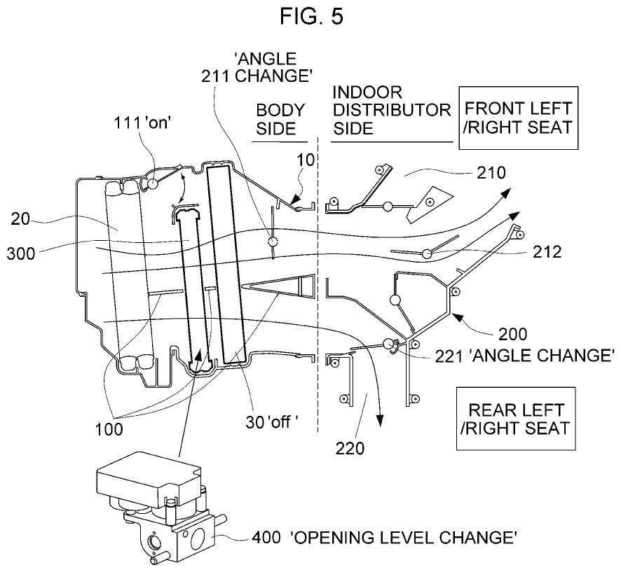

As illustrated in FIG. 5, the temperature in the internal condenser 300 is raised by changing an opening level of the three-way valve 400, the cold wind passing through the evaporator 20 raises an overall wind temperature while a front seat air volume control door 211 is closed, and when the temperature is different for each zone, the target final temperature may be made for each zone by use of the 4-zone HV PTC heater 30, and furthermore, to control the air volume for each zone, resistance of the wind is made by changing angles of the front/rear seat air volume control door 211/221 to control the air volume.

Under the maximum (MAX) heating condition (when the temperature/the air volume is different for each of 4 zones),

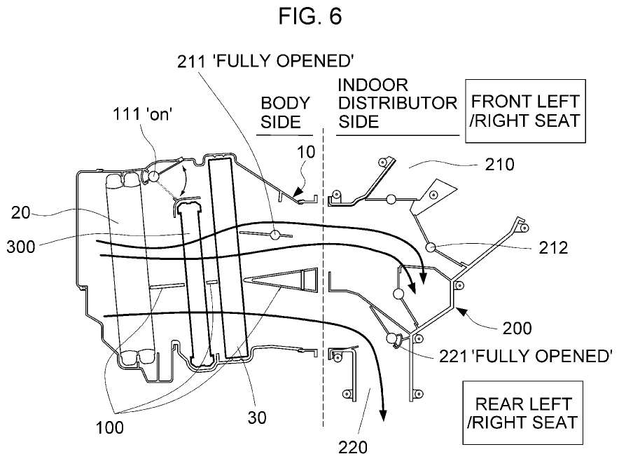

As illustrated in FIG. 6, a temperature of a wind is raised by receiving heat of the evaporator 20 and the internal condenser 300 while passing through the internal condenser 300 and the 4-zone HV PTC heater 30 to discharge the wind at a maximum heating temperature.

In the instant case, the front/rear seat air volume control door 211/221 is fully opened to secure the maximum air volume.

Under the general heating condition,

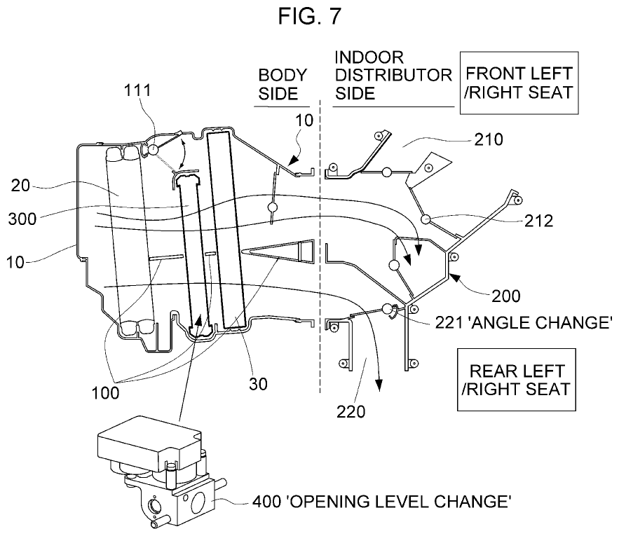

As illustrated in FIG. 7, the temperature in the internal condenser 300 is raised by changing an opening level of the three-way valve 400, the cold wind passing through the evaporator 20 raises an overall wind temperature while passing through the front seat air volume control door 211, and when the temperature is different for each zone, the target final temperature may be discharged for each zone by use of the 4-zone HV PTC heater 30 again.

Accordingly, in the individual air conditioning control system for an electric vehicle according to an exemplary embodiment of the present disclosure, the HVAC body and the indoor distributor are separated, and the 4-zone control (front left and right seats and rear left and right seats) is possible by use of one blower.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

The scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An individual air conditioning control system for a vehicle, the individual air conditioning control system comprising:
a heating, ventilation, and air conditioning (HVAC) body;
an evaporator provided in the HVAC body, a PTC heater, an input unit for receiving set temperature of each of a driver's seat and a passenger's seat, left and right temperature sensing units of sensing an air temperature passing through a left side and a right side of the PTC heater, a control unit of outputting a control signal for controlling the PTC heater based on the set temperature input from the input unit and a measurement temperature measured from each of the left and right temperature sensing units; and
a power supply unit of adjusting power supplied to the PTC heater according to the output control signal of the control unit,
wherein a warm wind or a cold wind is discharged to the driver's seat and the passenger's seat according to the control signal of the control unit, and
wherein an inside of the HVAC air conditioning control system is separated by a partition and an indoor distributor provided in the HVAC body to enable multi-zone control by use of a blower.

2. The system of claim 1,
wherein the partition is provided to be horizontally airtight at an intermediate position of the evaporator and the PTC heater provided in the HVAC body, and
wherein the indoor distributor includes a front seat air volume control door, a mode door provided in a front seat discharge hole, and a rear seat air volume control door provided in a rear seat discharge hole to send a wind output from the HVAC body to the front seat discharge hole.

3. The system of claim 2,
wherein the HVAC air conditioning control system is separated into a upper flow path and a lower flow path by the partition,
wherein the front seat air volume control door is provided in the upper flow path, and the rear seat air volume control door is provided in the lower flow path.

4. The system of claim 3,
wherein the mode door is provided in the upper flow path.

5. The system of claim 1, further including an internal condenser provided between the evaporator and the PTC heater and heating up a wind passing through a heat pump system in the evaporator.

6. The system of claim 5, wherein a bypass door is provided at an upper portion of the internal condenser so that the cold wind directly passes therethrough during maximum cooling.

7. The system of claim 2, wherein a front seat air volume control door is provided on a top portion of the partition at a heater side, which enables an individual air volume control of the front seat discharge hole by generating a resistance to a flow of a wind in the HVAC body by adjusting an angle of the front seat air volume control door.

8. The system of claim 2, wherein a rear seat air volume control door is provided in the indoor distributor on a bottom portion of the partition at a heater side, which enables an individual air volume control of the rear seat discharge hole by generating a resistance to a flow of a wind in the indoor distributor by adjusting an angle of the rear seat air volume control door.

9. The system of claim 5, wherein a three-way valve is provided between the evaporator and the PTC heater to block hot refrigerant which flows to the internal condenser during cooling.

10. The system of claim 1, wherein the PTC heater adopts a 4-zone HV PTC heater which is vertically separated around the partition, but enables adjustment of a heating step for each of upper left and right zones and lower left and right zones.

11. The system of claim 1, wherein in the HVAC air conditioning control system,
under a maximum (MAX) cooling condition,
a cold wind passing through the evaporator prevents hot refrigerant from flowing to an internal condenser by use of a three-way valve and a 4-zone HV PTC heater is turned off to secure cooling performance and a bypass door is opened to minimize air ventilation resistance which moves to an air vent and a front seat air volume door and a rear seat air volume door are fully opened to secure an air volume to the maximum.

12. The system of claim 1, wherein in the HVAC air conditioning control system,
under a general cooling condition,
a temperature of an internal condenser is raised by changing a three-way valve opening level, and an overall wind temperature is raised while passing through the evaporator and when a temperature is different for each zone, a target final temperature for each zone is made by use of a 4-zone HV PTC heater, and resistance of the wind is made by changing an angle of at least one of a front seat air volume control door and a rear seat air volume control door to control an air volume for each zone to control the air volume.

13. The system of claim 1, wherein in the HVAC air conditioning control system,
under a maximum (MAX) heating condition,
a temperature of a wind generated while a cold wind passing through the evaporator passes through an internal condenser and the 4-zone HV PTC heater is raised to discharge the wind at a maximum heating temperature.

14. The system of claim 1, wherein in the HVAC air conditioning control system,
under a general heating condition,
a temperature in the internal condenser is raised by changing an opening level of a three-way valve, a cold wind passing through the evaporator raises an overall wind temperature while passing through a front seat air volume control door, and when the temperature is different for each zone, a target final temperature is discharged for each zone by use of a 4-zone HV PTC heater.

15. An individual air conditioning control system for a vehicle, which discharges a warm wind or a cold wind to a driver's seat and a passenger's seat according to a signal of a control unit, the system comprising:
an evaporator provided in a heating, ventilation, and air conditioning (HVAC) body in which external air is introduced;
an internal condenser and a heater provided in a distance from the evaporator, which are provided in sequence;
a bypass door provided at an upper portion of the internal condenser so that the cold wind directly pass therethrough during maximum cooling; and
a partition provided at an intermediate position of the evaporator and the heater to be horizontally airtight.

16. The system of claim 15,
wherein the partition is provided to be horizontally airtight at an intermediate position of the evaporator and the heater provided in the HVAC body, and
wherein the indoor distributor includes a front seat air volume control door, a mode door provided in a front seat discharge hole, and a rear seat air volume control door provided in a rear seat discharge hole to send a wind output from the HVAC body to the front seat discharge hole.

17. The system of claim 16,
wherein the HVAC air conditioning control system is separated into a upper flow path and a lower flow path by the partition,
wherein the front seat air volume control door is provided in the upper flow path, and the rear seat air volume control door is provided in the lower flow path.

18. The system of claim 17,
wherein a mode door is provided in the upper flow path.
